(19) United States
(12) Patent Application Publication
(10) Pub. No.: US 2002/0020761 A1
(43) Pub. Date: Feb. 21, 2002

(54) Aromatic mist delivery system

(76) Inventor: Gregory Robert Jordan, Phoenix, AZ (US)

Correspondence Address: Gregory R. Jordan, 1642 N. 24 St., Phoenix, AZ, 85008, US

(21) Appl. No.: 09/974,397

(22) Filed: Oct. 10, 2001

Related U.S. Application Data
(60) Provisional application No. 60/227,626, filed on Aug. 17, 2000.

(51) Int. Cl. B05B 7/26; B65D 83/00

(52) U.S. Cl. 239/310; 222/402.1

(57) ABSTRACT

Embodiment of an aromatic mist delivery system is disclosed which includes a container housing a cartridge or reservoir of fragrance or additive designed to be attached to water delivery systems or misting devices. As water passes through the container, scent or additive is transferred to the water for delivery throughout the system.

This invention pertains to an aromatic mist system for dispensing a volatilizable material such as a fragrance into the atmosphere utilizing infusion extraction. More particularly this invention pertains to a method and apparatus for delivering a fragrance, air freshener, insect repellant, animal or human pheremone, or any other approved chemical additive or agent for enhancing the environment utilizing water or fluid as the medium for delivery. Currently existing aromatic delivery systems require the application of heat, such as in incense or candles or the application of air flow across a cellulose pad saturated with perfume which when exposed to the atmosphere delivers the fragrance via a dispersion of the airborne molecules, evaporation or both. One disadvantage of the present conventional fragrance or approved chemical additive delivery systems is the associated risk of heat and fire, such as in a candle or the inconvenient requirement for an air flow mechanism Accordingly, it would be highly desirable to provide a means for a fragrance or approved chemical additive delivery system which can incorporate existing fluid disbursal mechanisms such as in a misting devise, utilizing the principle of infusion extraction. Additionally, utilizing this process the fragrance or approved chemical additive will be suspended or dissolved in water droplets and less susceptible to removal from the environment by air currents.

Therefore it is a principal object of the instant invention to provide an improved method and apparatus for delivery of a fragrance or approved chemical additive or agent utilizing a delivery system from a cartridge or canister that attaches to the water or fluid misting device.

Another object of the invention is to provide an improved ability to deliver fragrance or approved chemical additive or agent in an environment that supplies or utilizes cooling or evaporative or moisturizing benefit in addition to the fragrance or approved chemical additive delivery system.

It is an object of the present invention to provide a dispensing devise which utilizes the present water vapor misting delivery system and provides the user with a simple and inexpensive means of delivery of the fragrance or approved chemical additive or agent in an outdoor or indoor environment.

It is a further object of the invention to provide an atmosphere treating device that delivers an enhancement or improvement to the immediate environment and at the same time cleans the delivery system of mineral deposits which clog the misting devise and plumbing fixtures.

It is a further object to provide a simple uncomplicated dispensing devise which can be manufactured economically from standard available materials and which can be used immediately without the need for extensive directions, incorporating a direct screw-on attachment to the existing misting devises.

Another object of the invention is to provide an improved method of delivery of the fragrance, pheremone, or approved chemical additive or agent to a wide area usage such as for agricultural or zoological applications.

The foregoing and other, further and more specific objects and advantages of the invention will be apparent from the following detailed description of the invention, taken in conjunction with the drawings, in which:

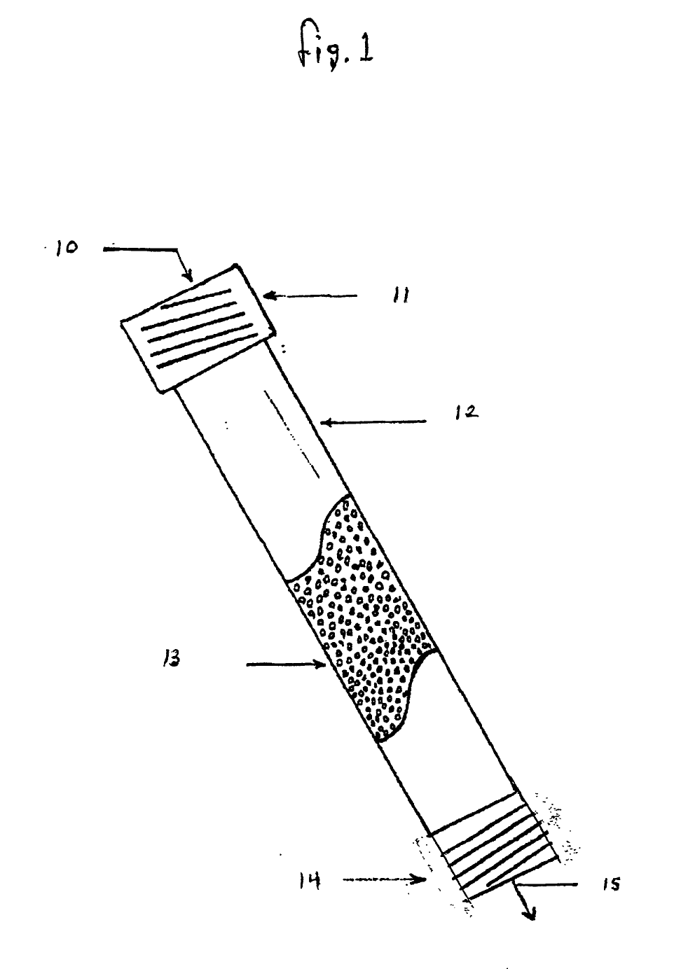

FIG. 1 Is a perspective view illustrating the aromatic mist delivery system assembly constructed in accordance with the principals of the invention;

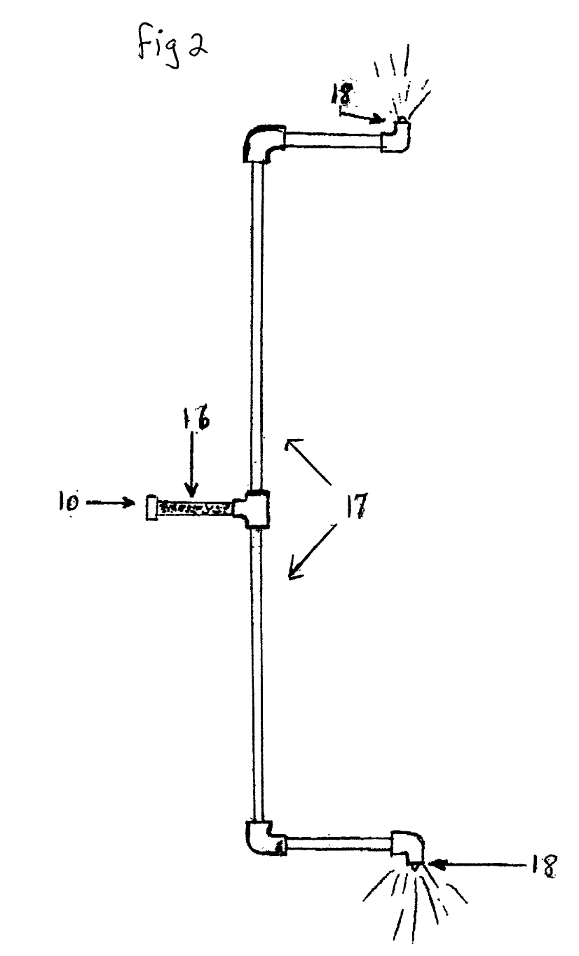

FIG. 2 Is a perspective view illustrating a mode of operation of the aromatic delivery system assembly of FIG. 1 utilizing the device.

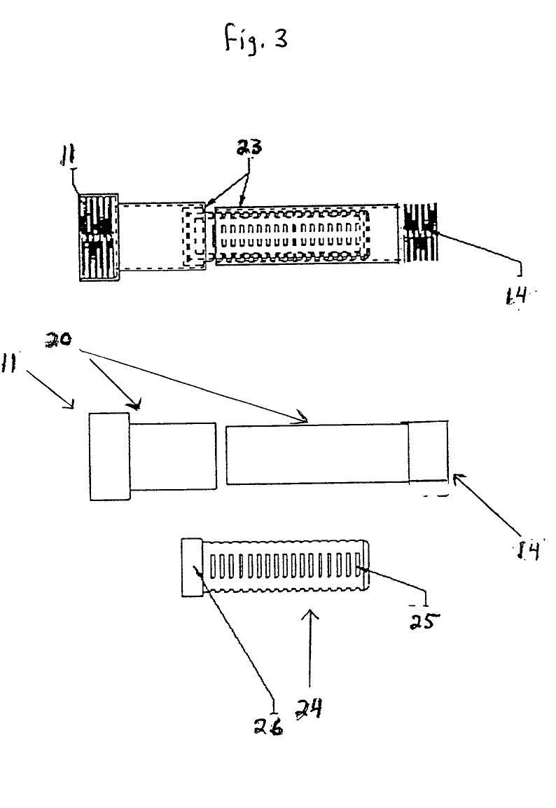

FIG. 3 Is a sectional view of the device.

Briefly, in accordance with the invention I provide a device for delivery of a fragrance or approved chemical additive or agent into the atmosphere through existing misting devices, evaporative coolers and air conditioning systems. The apparatus includes a container which serves as a reservoir for the fragrance or chemical additive. Standard hose connections or other plumbing connectors seal the container and incorporate the membrane or filter to prevent the additive in the cylinder from entering the misting device or supply lines to the apparatus. Utilizing the principle of infusion extraction, I provide the atmosphere treating device in the form of an aromatic mist delivery system as a novel method of distribution of the fragrance or substance through a membrane or water permeable cartridge or frame. This method includes the steps of providing water or fluid flow across and through the cartridge or container encasing the fragrance or additive material, and extracting the fragrance or additive. In still another embodiment of the invention I provide a novel method for administering the fragrance or approved chemical additive or agent into the atmosphere utilizing multiple distribution points for the fragrance or additive enhanced liquid. This method includes the steps of providing the liquid through the cartridge and across the volatilizable material and using standard available plumbing lines, such as PVC to distribute the fragrance or additive enhanced fluid to multiple outlets for mist emitters. This method includes the distribution of the fragrance or additive enhanced liquid from the cartridge in a base with emitters on each side of patio and lounge furniture. And in still a further embodiment of the invention, I provide for a means of using a replaceable cartridge or removable cylinder for introduction of the extracted fragrance or additive for residential, commercial, or agricultural purposes. This method includes the steps of providing the water or other fluid across the volatilizable material, fragrance or additive which can be removed and replenished upon the volatilizable material, fragrance or additive being expended or consumed. The enhanced volatilizable material can be disbursed in a wide area, such as for agricultural uses such as poultry and livestock and animal husbandry applications. In a further embodiment of the invention, I provide multiple replaceable cartridges or containers that hold replenished volatilizable material for substitution in the delivery system without need to remove the entire mechanisim.

Turning now to the drawings, which depict the presently preferred embodiments of the invention, for purposes of illustrating the practice thereof and not by way of limitation of the scope of the invention and which like reference characters refer to corresponding elements throughout the several views, FIG. 1 indicates the aromatic mist delivery system constructed in accordance with the invention and including a water entry location 10 with a female hose thread adaptor 11. A cylindrical housing 12 is attached to the female adaptor with a filter or screen(not visible)to seal the volatilizable material 13. The volatilizable material 13 in the form of pellets, beads or other fragrance or approved chemical additive substance, is depicted in the embodiment of the drawing of FIG. 1. At the water exit end of the cylinder 15 is attached a male plumbing adaptor 14 with a screen or filter(not visible)to prevent the exit of the volatilized material from the cylinder housing.

In the embodiment of FIG. 2 of the drawings, the water, liquid or fluid supply line enters the aromatic mist delivery system at entry location 10 similar to the embodiment set forth in FIG. 1 and connects to a standard plumbing T connection 16 for distribution along plumbing lines 17 proceeding in opposite directions to the misting emitters 18.

Further, in the embodiment of the invention illustrated in FIG. 3, there are sectional views of the aromatic mist delivery system utilizing a replaceable cartridge or container The housing container 20 attaches to the water supply with a female hose thread adapter 11. At the water exit end of the container is attached a male plumbing threaded adapter 14. The housing container is adapted for opening 23 to permit insertion of a replaceable cartridge 24. The replaceable cartridge has multiple holes or perforations 25 to allow dispersement of the volatizable material. The replaceable cartridge may be sealed 26 or utilize mechanical means to insure that the cartridge will perform as described in the embodiment of the above text. The mechanical means to seal 26 the cartridge will also allow the end user to replace the cartridge.

Having described my invention in such terms as to enable those of skill in the art to make and practice it and having described the presently preferred embodiments thereof, I claim

1. An atmosphere treating device, utilizing infusion extraction for dispensing volatilizable material such as a fragrance or approved chemical additive or agent into the atmosphere comprising:
A. A container or cartridge presenting an opening at each end
B. A filter or screen attached to the cartridge at each end adapted to allow the uninterrupted flow of water or fluid through the cartridge.
C. A collection or plurality of aromatic particles situated within the cartridge reservoir and adapted for infusion extraction by utilizing incoming fluid passing through the container or cartridge holding volatizable material, said period of particle transfer corresponding to the useful life of the aromatic impregnated pellets or volatilizable material or chemical additive.

2. The atmosphere treating device described in claim 1, wherein there are multiple exit ports and plumbing connectors allowing connection to multiple misting or discharge devises.

3. The atmosphere treating device described in claim 1, wherein the connectors at the ends of the container are modified or adapted for connection to an evaporative air conditioner as the dispensing device.

4. The atmosphere treating device container as claimed in claim 1, wherein the entry and discharge connections are modified or adapted for connection to a humidifier

5. The atmosphere treating device as described in claim 1, wherein the entry and discharge connectors are adapted or modified for connection with indoor and outdoor landscaping features such as water falls, ponds, and rock gardens

6. The atmosphere treating device described in claim 1, wherein the entry and discharge connectors are modified or adapted for connection with animal pens, stalls, tanks or display cases.

7. The atmosphere treating device claimed in claim 1, wherein the aromatic particles or material are contained in a replaceable cartridge or reservoir connected to a dispensing device.
